(19) United States
(12) Patent Application Publication
(10) Pub. No.: US 2014/0297281 A1
(43) Pub. Date: Oct. 2, 2014

(54) SPEECH PROCESSING METHOD, DEVICE AND SYSTEM

(71) Applicant: FUJITSU LIMITED, Kawasaki-shi (JP)

(72) Inventors: Taro Togawa, Kawasaki (JP); Chisato Shioda, Kawasaki (JP); Takeshi Otani, Kawasaki (JP)

(73) Assignee: FUJITSU LIMITED, Kawasaki-shi (JP)

(21) Appl. No.: 14/196,202

(22) Filed: Mar. 4, 2014

(30) Foreign Application Priority Data
Mar. 28, 2013 (JP) 2013-070682

(51) Int. Cl. G10L 15/22

(52) U.S. Cl. CPC G10L 15/22
USPC 704/251

(57) ABSTRACT

A speech processing method executed by a computer, the speech processing method includes: extracting, based on speech recognition for an input speech data, a plurality of word candidates including a first word candidate and a second word candidate from a memory, the plurality of word candidates being candidates for a word corresponding to the input speech data; determining at least one different part between the first word candidate and the second word candidate based on a comparison between the first word candidate and the second word candidate; and outputting the first word candidate with emphasis on the at least one different part.

### CROSS-REFERENCE TO RELATED APPLICATION

This application is based upon and claims the benefit of priority of the prior Japanese Patent Application No. 2013-070682, filed on Mar. 28, 2013, the entire contents of which are incorporated herein by reference.

### FIELD

The embodiments discussed herein are related to a technique for processing speech.

### BACKGROUND

There is a speech interaction system that repeatedly executes an interaction with a user and executes various tasks such as a search of information. The speech interaction system uses a speech recognition technique for converting speech input from a user into a word. The existing speech interaction system does not independently determine whether or not a speech recognition result is correct. Thus, the speech interaction system displays the speech recognition result on a display or the like and prompts the user to confirm whether or not the speech recognition result is correct.

If the speech interaction system frequently prompts the user to confirm whether or not a speech recognition result is correct, a load applied to the user increases. Thus, there is a demand to efficiently confirm whether or not a speech recognition result is correct.

For example, there is a conventional technique for slowly reproducing an overall word that has a low degree of reliability for speech recognition and prompting a user to confirm whether or not a speech recognition result is correct. For example, if the user says that “what is the weather in Okayama prefecture?”, the speech interaction system recognizes that “what is the weather in Wakayama prefecture?”, and the degree of reliability of the word “Wakayama” is low, the speech interaction system slowly reproduces “Wakayama” included in the speech recognition result and prompts the user to confirm whether or not the speech recognition result is correct. The techniques are disclosed in, for example, Japanese Laid-open Patent Publication Nos. 2003-208196 and 2006-133478.

### SUMMARY

According to an aspect of the invention, a speech processing method executed by a computer, the speech processing method includes: extracting, based on speech recognition for an input speech data, a plurality of word candidates including a first word candidate and a second word candidate from a memory, the plurality of word candidates being candidates for a word corresponding to the input speech data; determining at least one different part between the first word candidate and the second word candidate based on a comparison between the first word candidate and the second word candidate; and outputting the first word candidate with emphasis on the at least one different part.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the configuration of a speech processing apparatus according to the first embodiment;

FIG. 2 is a diagram illustrating the configuration of a selector according to the first embodiment;

FIG. 3 is a diagram describing a process that is executed by a likely candidate extractor according to the first embodiment;

FIG. 4 is a first diagram describing a process that is executed by an evaluator according to the first embodiment;

FIG. 5 is a second diagram describing the process that is executed by the evaluator according to the first embodiment;

FIG. 6 is a third diagram describing the process that is executed by the evaluator according to the first embodiment;

FIG. 7 is a diagram illustrating the configuration of an emphasis controller according to the first embodiment;

FIG. 8 is a diagram describing a process that is executed by a mora position matching section according to the first embodiment;

FIG. 9 is a flowchart of a process procedure of the speech processing apparatus according to the first embodiment;

FIG. 10 is a flowchart of a process procedure of the selector according to the first embodiment;

FIG. 11 is a diagram illustrating the configuration of a speech processing apparatus according to the second embodiment;

FIG. 12 is a diagram illustrating the configuration of a selector according to the second embodiment;

FIG. 13 is a diagram describing a process that is executed by a likely candidate extractor according to the second embodiment;

FIG. 14 is a diagram illustrating the configuration of a speech processing apparatus according to the third embodiment;

FIG. 15 is a diagram illustrating the configuration of a selector according to the third embodiment;

FIG. 16 is a diagram illustrating an example of word candidates extracted by a likely candidate extractor according to the third embodiment and degrees of reliability;

FIG. 17 is a first diagram describing a process that is executed by an evaluator according to the third embodiment;

FIG. 18 is a second diagram describing the process that is executed by the evaluator according to the third embodiment;

FIG. 19 is a third diagram describing the process that is executed by the evaluator according to the third embodiment;

FIG. 20 is a diagram illustrating the configuration of an emphasis controller according to the third embodiment;

FIG. 21 is a diagram describing a process that is executed by a mora position matching section according to the third embodiment;

FIG. 22 is a diagram illustrating an example of a speech processing system according to the fourth embodiment;

FIG. 23 is a diagram illustrating the configuration of a server according to the fourth embodiment; and

FIG. 24 is a diagram illustrating an example of a computer that executes a speech processing program.

### DESCRIPTION OF EMBODIMENTS

The aforementioned conventional techniques have a problem that an error of a speech recognition result is not easily found.

Regarding the conventional techniques, when an overall word that has a low degree of reliability for speech recognition is slowly reproduced, it is difficult to distinguish between the reproduced word and a correct recognition result and a user may not determine whether or not the result has been erroneously recognized. For example, regarding the aforementioned example, even if “Wakayama prefecture” that has a low degree of reliability is slowly reproduced, and the user listens to the overall words, “Wakayama prefecture” sounds similar to “Okayama prefecture” and the user may not determine whether the reproduced word is “Wakayama” or “Okayama”.

According to an aspect, the embodiments are intended to solve the aforementioned problems, and an object of the embodiments is to cause a user to easily find an error of a speech recognition result.

Hereinafter, the embodiments of a speech processing apparatus disclosed herein, a speech processing system disclosed herein, and a speech processing method disclosed herein are described in detail with reference to the accompanying drawings. However, the speech processing apparatus disclosed herein, the speech processing system disclosed herein, and the speech processing method disclosed herein are not limited to the embodiments.

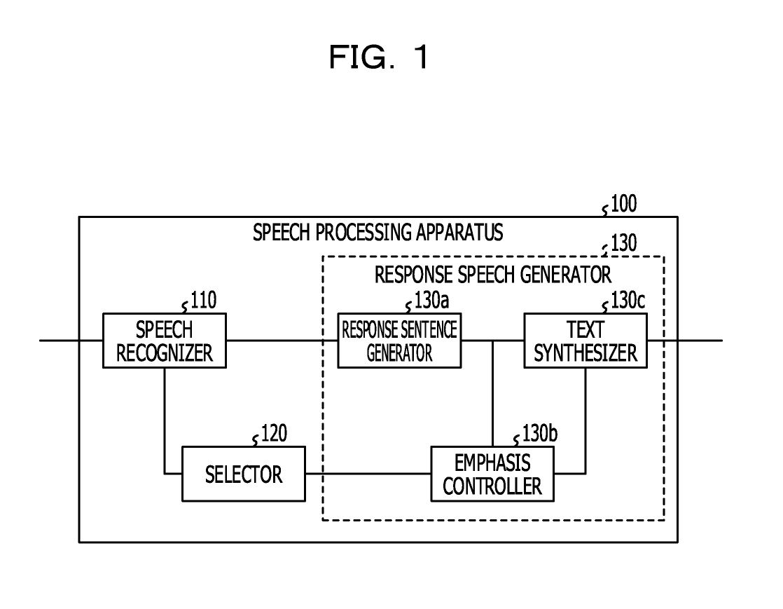

A speech processing apparatus according to the first embodiment is described. FIG. 1 is a diagram illustrating the configuration of the speech processing apparatus according to the first embodiment. As illustrated in FIG. 1, the speech processing apparatus 100 has a speech recognizer 110, a selector 120, and a response speech generator 130. The response speech generator 130 has a response sentence generator 130a, an emphasis controller 130b, and a text synthesizer 130c.

The speech recognizer 110 is a processor that executes speech recognition so as to convert speech input from a microphone or the like into a word and extracts a plurality of word candidates corresponding to the speech. The speech recognizer 110 calculates degrees of reliability of the word candidates. The speech recognizer 110 outputs, to the selector 120 and the response sentence generator 130a, information in which the word candidates are associated with the degrees of reliability. In the following description, speech or speech that is input from the microphone or the like is referred to as an input speech.

An example of a process that is executed by the speech recognizer 110 is described in detail. The speech recognizer 110 holds a reference table in which a plurality of words are associated with reference patterns of speech corresponding to the words. The speech recognizer 110 calculates a characteristic vector of input speech on the basis of a frequency characteristic of the input speech, compares the calculated characteristic vector with the reference patterns of the reference table, and calculates degrees of similarities between the characteristic vector and the reference patterns. The degrees of the similarities between the characteristic vector and the reference patterns are referred to as degrees of reliability.

The speech recognizer 110 extracts, as a word candidate, a reference pattern other than a reference pattern of which a degree of reliability with respect to the characteristic vector is very close to 0. For example, the speech recognizer 110 extracts, as a word candidate, a reference pattern of which a degree of reliability with respect to the characteristic vector is equal to or larger than 0.1. The speech recognizer 110 outputs, to the selector 120 and the response speech generator 130, information in which the extracted word candidate is associated with the degree of reliability.

A process that is executed by the speech recognizer 110 to calculate degrees of reliability of the word candidates is not limited to the aforementioned process and may be executed using any known technique. For example, the speech recognizer 110 may calculate degrees of reliability of the word candidates using the technique disclosed in Japanese Laid-open Patent Publication No. 4-255900.

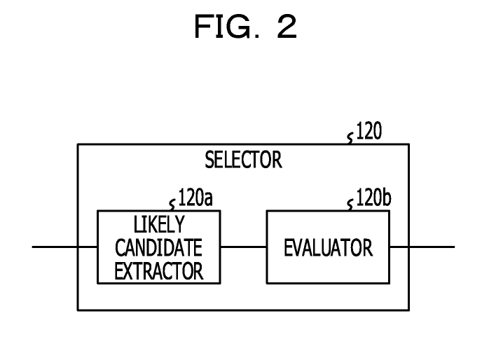

The selector 120 is a processor that selects a part corresponding to a difference between the plurality of word candidates. FIG. 2 is a diagram illustrating the configuration of the selector according to the first embodiment. As illustrated in FIG. 2, the selector 120 has a likely candidate extractor 120a and an evaluator 120b.

The likely candidate extractor 120a extracts, on the basis of the degrees of reliability of the plurality of word candidates, a word candidate of which a degree of reliability is equal to or larger than a threshold. The likely candidate extractor 120a outputs a combination of the extracted word candidate and the degree of reliability of the extracted word candidate to the evaluator 120b.

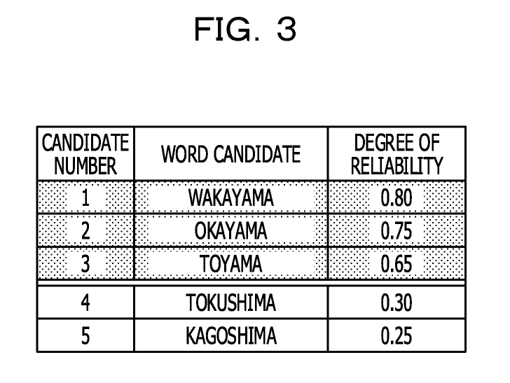

FIG. 3 is a diagram describing a process that is executed by the likely candidate extractor according to the first embodiment. For example, it is assumed that relationships between the word candidates received from the speech recognizer 110 and the degrees of reliability are relationships illustrated in FIG. 3 and that the predetermined threshold is “0.6”. In this case, the likely candidate extractor 120a extracts combinations of word candidates of candidate numbers 1 to 3 and degrees of reliability of the word candidates. The likely candidate extractor 120a outputs, to the evaluator 120b, information of the combinations of the extracted word candidates and the degrees of reliability of the extracted word candidates.

The evaluator 120b is a processor that compares the word candidates with each other and selects a part corresponding to a difference between the word candidates. In the following description, a word candidate of which a degree of reliability is largest is referred to as a first word candidate, and other word candidates are referred to as second word candidates. In an example illustrated in FIG. 3, a word candidate “Wakayama” of which a degree of reliability is “0.80” is a first word candidate, and a word candidate “Okayama” of which a degree of reliability is “0.75” and a word candidate “Toyama” of which a degree of reliability is “0.65” are second word candidates.

The evaluator 120b calculates scores for matching the first word candidate with the second word candidates, sums the calculated matching scores, and thereby calculates a final matching score for the first word candidate. For example, the evaluator 120b compares the first word candidate “Wakayama” with the second word candidate “Okayama” and calculates a matching score. In addition, the evaluator 120b compares the first word candidate “Wakayama” with the other second word candidate “Toyama” and calculates a matching score. The evaluator 120b sums the calculated matching scores and thereby calculates a final matching score for the first word candidate.

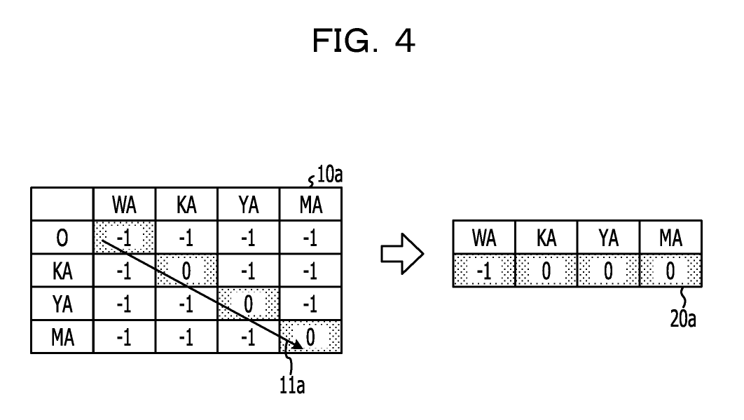

The evaluator 120b uses DP matching to calculate the matching scores, for example. FIGS. 4, 5, and 6 are diagrams describing a process that is executed by the evaluator 120b according to the first embodiment. First, the process is described with reference to FIG. 4. FIG. 4 describes the process of comparing the first word candidate “Wakayama” with the second word candidate “Okayama”. The evaluator 120b compares portions or characters of the first word candidate with portions of characters of the second word candidate. If a portion or character of the first word candidate matches a portion or character of the second word candidate, the evaluator 120b provides a score “0” to the character of the first word candidate. If the portion or character of the first word candidate does not match the portion or character of the second word candidate, the evaluator 120b provides a score “−1” to the portion or character of the first word candidate. In this manner, the evaluator 120b generates a table 10a by providing the scores.

The evaluator 120b identifies scores for the characters of the first word candidate by selecting a path on which larger scores among scores for the characters of the first word candidate exist on the basis of the table 10a on a priority basis. In an example illustrated in FIG. 4, a path 11a is selected and scores for the characters of the first word candidate are indicated in a score table 20a. Specifically, a score for “wa” is “−1” and scores for “ka”, “ya”, and “ma” are “0”.

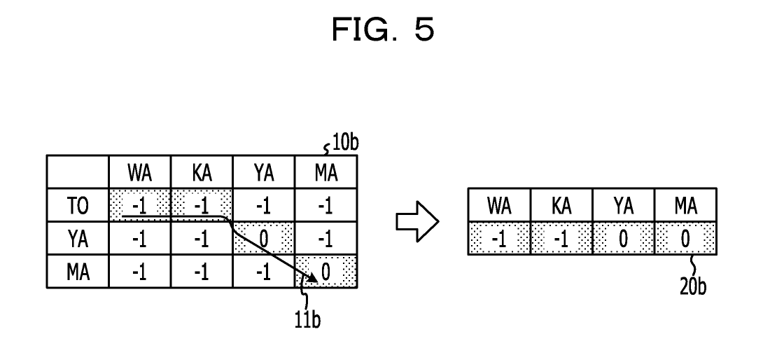

The process is described with reference to FIG. 5. FIG. 5 describes the process of comparing the first word candidate “Wakayama” with the second word candidate “Toyama”. The evaluator 120b compares the characters of the first word candidate with characters of the second word candidate. If a character of the first word candidate matches a character of the second word candidate, the evaluator 120b provides a score “0” to the character of the first word candidate. If the character of the first word candidate does not match the character of the second word candidate, the evaluator 120b provides a score “−1” to the character of the first word candidate. In this manner, the evaluator 120b generates a table 10b by providing the scores.

The evaluator 120b identifies scores for the characters of the first word candidate by selecting a path on which larger scores among scores for the characters of the first word candidate exist on the basis of the table 10b on a priority basis. In an example illustrated in FIG. 5, a path 11b is selected and scores for the characters of the first word candidate are indicated in a score table 20b. Specifically, scores for “wa” and “ka” are “−1” and scores for “ya” and “ma” are “0”.

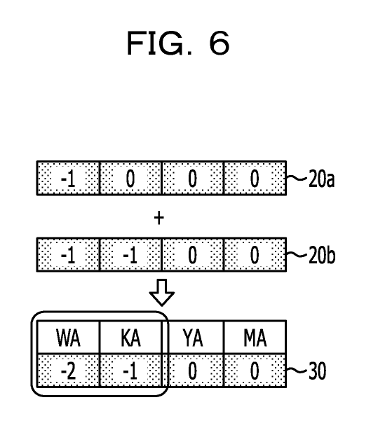

The process is described with reference to FIG. 6. The evaluator 120b sums the score table 20a and the score table 20b for each of the characters of the first word candidate and thereby calculates a score table 30 for the first word candidate.

The evaluator 120b selects, on the basis of the score table 30, a part included in the first word candidate and corresponding to a difference between the first word candidate and the second word candidates. For example, the evaluator 120b selects a score that is smaller than “0” from among scores of the score table 30. Then, the evaluator 120b selects, as the part corresponding to the difference, a character corresponding to the selected score. In an example illustrated in FIG. 6, the evaluator 120b selects, as the part corresponding to the difference, “wa” and “ka” from among the characters “wa”, “ka”, “ya”, and “ma” of the first word candidate. The evaluator 120b outputs information of the selected part to the emphasis controller 130b.

Return to FIG. 1. The response sentence generator 130a is a processor that generates a response sentence that is used to check with the user whether or not a speech recognition result is correct. For example, the response sentence generator 130a holds templates of character strings of multiple types and generates a response sentence by synthesizing a word candidate received from the speech recognizer 110 with a template. The response sentence generator 130a outputs information of the generated response sentence to the emphasis controller 130a and the text synthesizer 130c.

For example, when receiving a plurality of word candidates, the response sentence generator 130a selects a word candidate having the largest degree of reliability and generates audio such as a response sentence. For example, if the word candidate of which the degree of reliability is largest is “Wakayama”, the response sentence generator 130a synthesizes the word candidate with a template indicating “Is it ** ?” and generates a response sentence “Is it Wakayama?”.

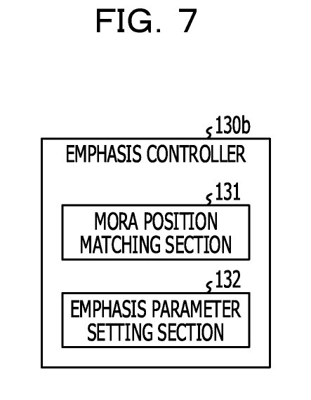

The emphasis controller 130b is a processor that selects a part included in the response sentence and to be distinguished or emphasized and notifies the text synthesizer 130c of the selected part to be emphasized or distinguished from the rest of the selected word candidate and a parameter for emphasizing the part. FIG. 7 is a diagram illustrating the configuration of the emphasis controller according to the first embodiment. As illustrated in FIG. 7, the emphasis controller 130b has a mora position matching section 131 and an emphasis parameter setting section 132.

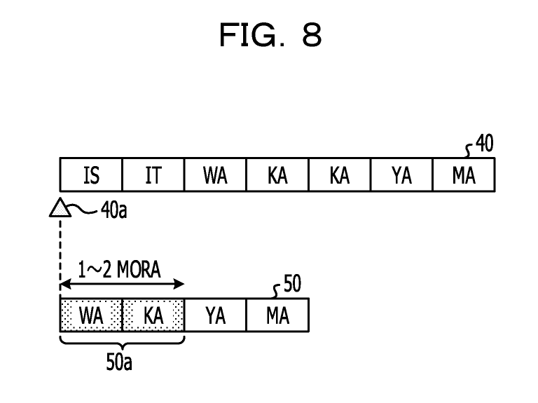

The mora position matching section 131 is a processor that selects, on the basis of the information received from the evaluator 120b and indicating the part corresponding to the difference, a part included in the response sentence to be emphasized. FIG. 8 is a diagram describing a process that is executed by the mora position matching section 131 according to the first embodiment. As illustrated in FIG. 8, the mora position matching section 131 crosschecks a start mora position 40a of a response sentence 40 with a part 50a included in a word candidate 50 and corresponding to the differences and thereby calculates a part included in the response sentence 40 and to be emphasized. In an example illustrated in FIG. 8, the first and second characters that are included in the response sentence 40 and correspond to the part 50a corresponding to the differences are “wa” and “ka”, respectively. Thus, the part to be emphasized is moras 1 and 2.

The emphasis parameter setting section 132 outputs a parameter indicating a set amplitude amount to the text synthesizer 130c. For example, the emphasis parameter setting section 132 outputs, to the text synthesizer 130c, information indicating that “the part to be emphasized is amplified by 10 dB”.

The text synthesizer 130c is a processor that generates, on the basis of the information of the response sentence, information of the part to be emphasized, and the parameter for the emphasis, response speech corresponding to the response sentence and including emphasized speech of the part and outputs the generated response speech. For example, the text synthesizer 130c executes language analysis on the response sentence, identifies prosodies corresponding to words of the response sentence, synthesizes the identified prosodies, and thereby generates the response speech. The text synthesizer 130c emphasizes a prosody of speech corresponding to a character of the part included in the response speech and to be emphasized and thereby generates the response speech including emphasized speech of the part.

For example, if the part to be emphasized is the “moras 1 and 2” and the parameter indicates that “the part to be emphasized will be amplified by 10 dB”, the text synthesizer 130c amplifies, by 10 dB, power of speech of a part “Waka” included in the response sentence “Is it Wakayama?” and thereby generates response speech of the response sentence. The response speech generated by the text synthesizer 130c is output from a speaker or the like. For example, the response speech is output, while the speech of the part “Waka” of the response sentence “Is it Wakayama?” is more emphasized than the other words of the response sentence.

If a plurality of word candidates are not extracted by the selector 120, the response speech generator 130 converts information of a response sentence into response speech without changing the response sentence and outputs the response speech.

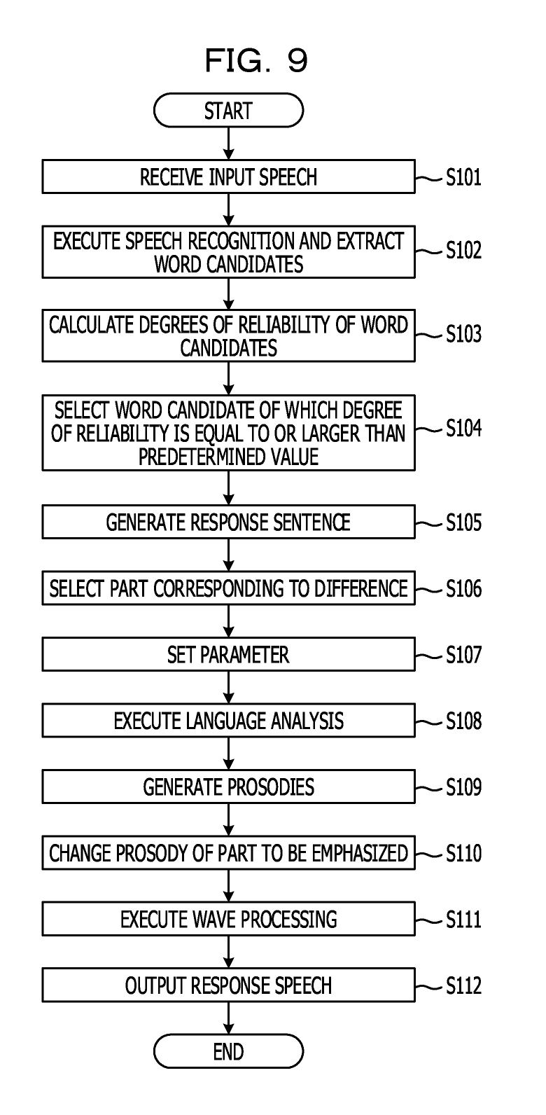

Next, a process procedure of the speech processing apparatus 100 according to the first embodiment is described. FIG. 9 is a flowchart of the process procedure of the speech processing apparatus according to the first embodiment. The process procedure illustrated in FIG. 9 is executed when the speech processing apparatus 100 receives input speech. As illustrated in FIG. 9, the speech processing apparatus 100 receives input speech (in step S101), executes the speech recognition, and extracts word candidates (in step S102).

The speech processing apparatus 100 calculates degrees of reliability of the word candidates (in step S103) and selects word candidates of which degrees of reliability are equal to or larger than a predetermined value (in step S104). The speech processing apparatus 100 generates a response sentence (in step S105) and selects a part corresponding to a difference between the selected word candidates (in step S106).

The speech processing apparatus 100 sets a parameter (in step S107) and executes the language analysis (in step S108). The speech processing apparatus 100 generates prosodies (in step S109) and changes a prosody of a part to be emphasized (in step S110). The speech processing apparatus 100 executes waveform processing (in step S111) and outputs response speech (in step S112).

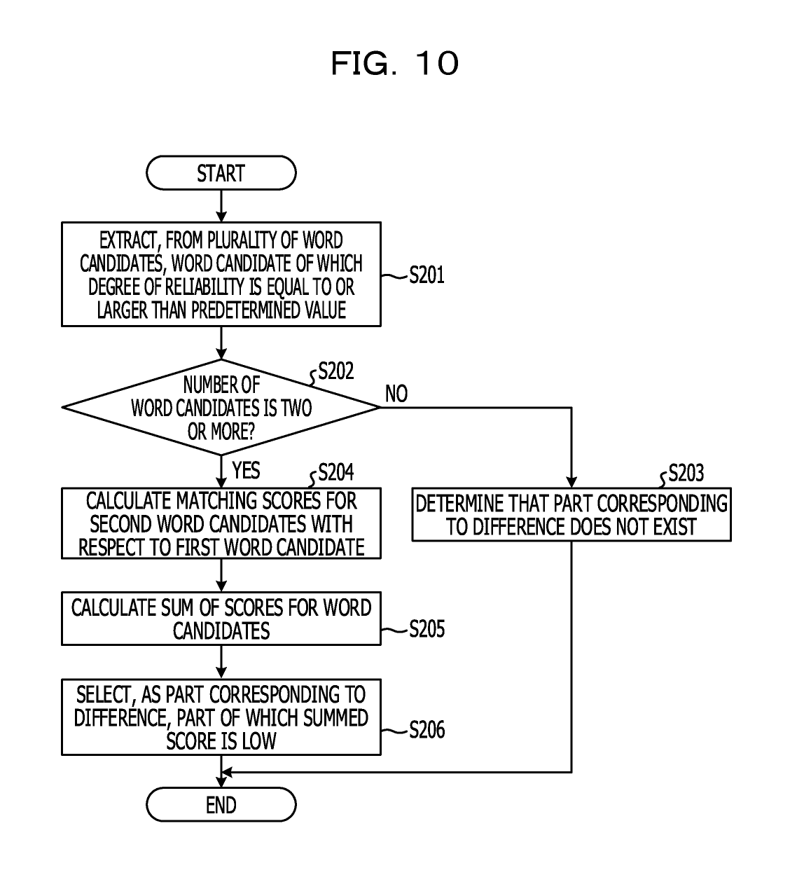

Next, an example of a process procedure of the selector 120 illustrated in FIG. 1 is described. FIG. 10 is a flowchart of the process procedure of the selector according to the first embodiment. The selector 120 extracts, from a plurality of word candidates, a word candidate of which a degree of reliability is equal to or larger than a predetermined value (in step S201).

The selector 120 determines whether or not the number of word candidates is two or more (in step S202). If the number of word candidates is not two or more (No in step S202), the selector 120 determines that a part corresponding to a difference does not exist (in step S203).

If the number of word candidates is two or more (Yes in step S202), the selector 120 calculates matching scores for second word candidates with respect to a first word candidate (in step S204). The selector 120 sums the scores for the word candidates (in step S205). The selector 120 selects, as a part corresponding to a difference between the word candidates, a part for which the summed score is low (in step S206).

Next, effects of the speech processing apparatus 100 according to the first embodiment are described. The speech processing apparatus 100 selects, on the basis of a plurality of word candidates recognized by the speech recognizer 110, a part corresponding to a difference between the word candidates. The speech processing apparatus 100 outputs response speech including speech of which the volume has been increased and that corresponds to the part corresponding to the difference between the word candidates. In this manner, the speech processing apparatus 100 according to the first embodiment emphasizes only speech of a part corresponding to a difference between word candidates without emphasizing speech of an overall word and outputs response speech including the emphasized speech of the part. Thus, an error of a speech recognition result may be easily found. In addition, if this technique is applied to a speech interaction system, the user may easily notice an erroneously recognized part and correctly pronounce a phrase, and the efficiency of an interaction executed to correct the erroneous recognition may be improved.

### Second Embodiment

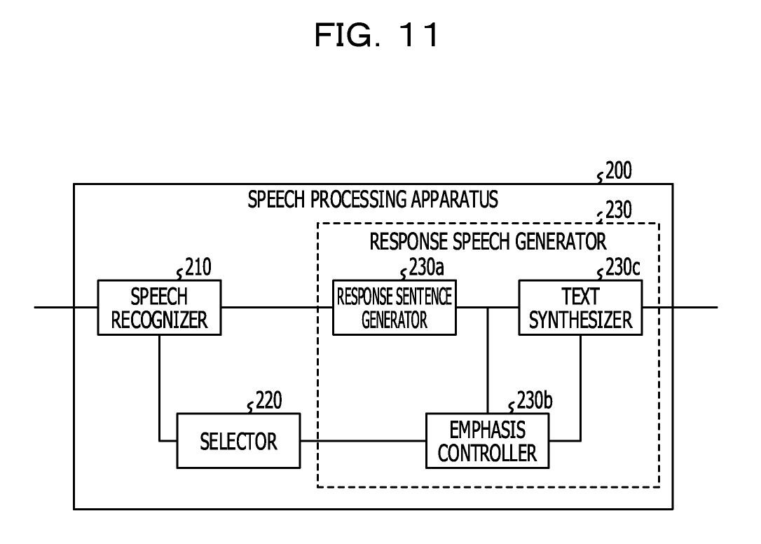

A speech processing apparatus according to the second embodiment is described below. FIG. 11 is a diagram illustrating the configuration of the speech processing apparatus according to the second embodiment. As illustrated in FIG. 11, the speech processing apparatus 200 has a speech recognizer 210, a selector 220, and response speech generator 230. The response speech generator 230 has a response sentence generator 230a, an emphasis controller 230b, and a text synthesizer 230c.

The speech recognizer 210 is a processor that executes the speech recognition so as to convert speech input from a microphone or the like into a word and extracts a plurality of word candidates corresponding to the speech. In addition, the speech recognizer 210 calculates degrees of reliability of the word candidates. The speech recognizer 210 outputs, to the selector 220 and the response speech generator 230, information in which the word candidates are associated with the degrees of reliability. A specific description of the speech recognizer 210 is the same as or similar to the description of the speech recognizer 110 according to the first embodiment.

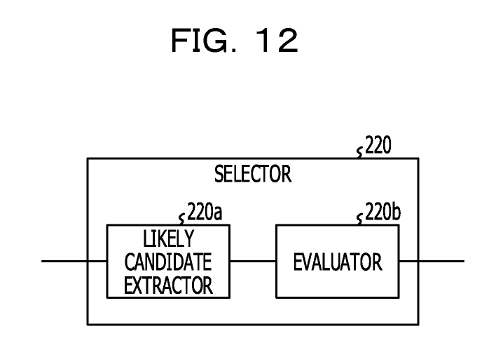

The selector 220 is a processor that selects a part corresponding to a difference between the plurality of word candidates. FIG. 12 is a diagram illustrating the configuration of the selector according to the second embodiment. As illustrated in FIG. 12, the selector 220 has a likely candidate extractor 220a and an evaluator 220b.

The likely candidate extractor 220a extracts, on the basis of degrees of reliability of the plurality of word candidates, a word candidate of which a degree of reliability is different by a predetermined threshold or less from the largest degree of reliability. The likely candidate extractor 220a outputs a combination of the extracted word candidate and the degree of reliability of the extracted word candidate to the evaluator 220b.

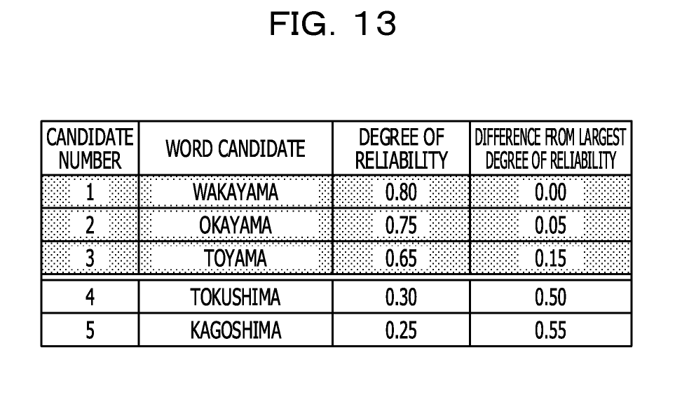

FIG. 13 is a diagram describing a process that is executed by the likely candidate extractor according to the second embodiment. In an example illustrated in FIG. 13, candidate numbers, word candidates, degrees of reliability, and differences between the degrees of reliability and the largest degree of reliability are associated with each other. If the predetermined threshold is “0.2”, word candidates of which degrees of reliability are different by the predetermined threshold or less from the largest degree of reliability are word candidates of candidate numbers 1 to 3. Thus, the likely candidate extractor 220a outputs information of combinations of the word candidates of the candidate numbers 1 to 3 and the degrees of reliability of the word candidates to the evaluator 220b.

The evaluator 220b is a processor that compares the word candidates with each other and selects a part corresponding to a difference between the word candidates. In the same manner as the first embodiment, a word candidate of which a degree of reliability is largest is referred to as a first word candidate, and other word candidates are referred to as second word candidates. The evaluator 220b executes the same process as the evaluator 120b described in the first embodiment, selects the part corresponding to the difference between the word candidates, and outputs information of the selected part corresponding to the difference to the emphasis controller 230b.

The response sentence generator 230a is a processor that generates a response sentence that is used to prompt the user to check whether or not a speech recognition result is correct. A process that is executed by the response sentence generator 230a to generate the response sentence is the same as or similar to the process executed by the response sentence generator 130a described in the first embodiment. The response sentence generator 230a outputs information of the generated response sentence to the emphasis controller 230b and the text synthesizer 230c.

The emphasis controller 230b is a processor that selects a part included in the response sentence and to be emphasized and notifies the text synthesizer 230c of the selected part to be emphasized and a parameter for emphasizing the selected part. The emphasis controller 230b identifies the part (to be emphasized) in the same manner as the emphasis controller 130b described in the first embodiment. The emphasis controller 230b outputs, to the text synthesizer 230c, information indicating that “the persistence length of the part to be emphasized will be doubled” as the parameter.

The text synthesizer 230c is a processor that generates, on the basis of the information of the response sentence, the information of the part to be emphasized, and the parameter for emphasizing the part, response speech corresponding to the response sentence and including emphasized speech of the part and outputs the generated response speech. For example, the text synthesizer 230c executes the language analysis on the response sentence, identifies prosodies corresponding to words of the response sentence, synthesizes the identified prosodies, and thereby generates the response speech. The text synthesizer 230c emphasizes a prosody of speech corresponding to a character of the part included in the response speech and to be emphasized and thereby generates the response speech including the emphasized speech of the part.

For example, if the part to be emphasized is the “moras 1 and 2” and the parameter indicates that “the persistence length of the part to be emphasized will be doubled”, the text synthesizer 230c doubles the persistence length of a prosodic part of the part “Waka” included in the response sentence “Is it Wakayama?” and generates response speech of the response sentence. The response speech generated by the text synthesizer 230c is output from a speaker or the like. The part “Waka” included in the response sentence “Is it Wakayama?” is output for a longer time period than the other part of the response sentence and is thereby emphasized.

Next, effects of the speech processing apparatus 200 according to the second embodiment are described. The speech processing apparatus 200 selects, on the basis of a plurality of word candidates recognized by the speech recognizer 210, a part corresponding to a difference between the word candidates. The speech processing apparatus 200 outputs response speech including speech of the part that corresponds to the difference between the word candidates and of which the persistence length has been increased. Since the speech processing apparatus 200 according to the second embodiment increases only the persistence length of a part corresponding to a difference between word candidates without increasing the persistence length of an overall word and outputs response speech including speech of the part corresponding to the difference, an error of a speech recognition result may be easily found. In addition, if this technique is applied to the speech interaction system, the user may easily notice an erroneously recognized part and correctly pronounce a phrase, and the efficiency of an interaction executed to correct the erroneous recognition may be improved.

The speech processing apparatus 200 according to the second embodiment may use information indicating that “the pitch of the part corresponding to the difference will be doubled” as the parameter. Then, the speech processing apparatus 200 may emphasize the part corresponding to the difference. The pitch corresponds to a fundamental frequency, for example. If the part to be emphasized is the “moras 1 and 2” and the parameter indicates that “the pitch of the part to be emphasized will be doubled”, the text synthesizer 230c doubles the pitch of the prosodic part of the part “Waka” included in the response sentence “Is it Wakayama?” and thereby generates response speech including emphasized speech that corresponds to the part and is lower than normal speech. Since the speech processing apparatus 200 according to the second embodiment lowers only the speech pitch of the part corresponding to the difference and outputs the response speech including the emphasized speech of the part, an error of a speech recognition result may be easily found. The speech processing apparatus 200 may decrease the pitch of the part by ½ and emphasize the speech of the part.

### Third Embodiment

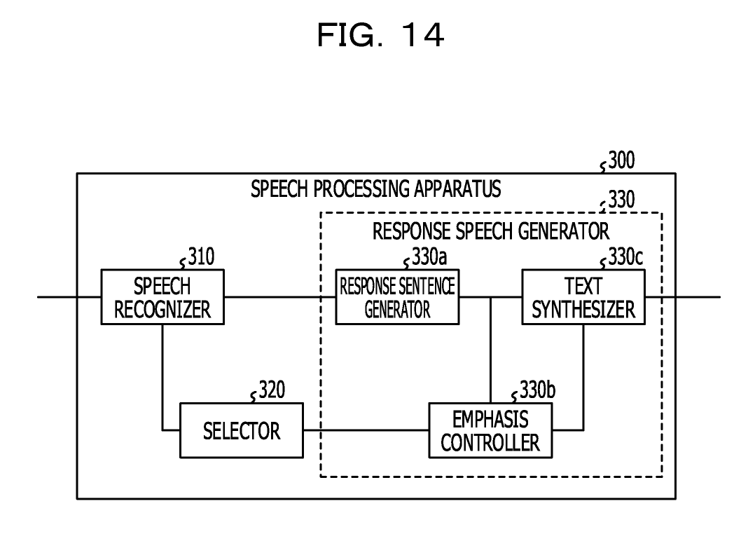

A speech processing apparatus according to the third embodiment is described. FIG. 14 is a diagram illustrating the configuration of the speech processing apparatus according to the third embodiment. As illustrated in FIG. 14, the speech processing apparatus 300 has a speech recognizer 310, a selector 320, response speech generator 330. The response speech generator 330 has a response sentence generator 330a, an emphasis controller 330b, and a text synthesizer 330c.

The speech recognizer 310 is a processor that executes the speech recognition so as to convert speech input from a microphone or the like into a word and extracts a plurality of word candidates corresponding to the speech. In addition, the speech recognizer 310 calculates degrees of reliability of the word candidates. The speech recognizer 310 outputs, to the selector 320 and the response sentence generator 330a, information in which the word candidates are associated with the degrees of reliability. In the following description, speech that is input from the microphone or the like is referred to as input speech.

An example of a process that is executed by the speech recognizer 310 is described in detail. The speech recognizer 310 holds a reference table in which a plurality of words are associated with reference patterns of speech corresponding to the words. The speech recognizer 310 calculates a characteristic vector of input speech on the basis of a frequency characteristic of the input speech, compares the calculated characteristic vector with the reference patterns of the reference table, and calculates degrees of similarities between the characteristic vector and the reference patterns. The degrees of the similarities between the characteristic vector and the reference patterns are referred to as degrees of reliability.

The speech recognizer 310 extracts, as a word candidate, a reference pattern other than a reference pattern of which a degree of reliability with respect to the characteristic vector is very close to 0. For example, the speech recognizer 310 extracts, as a word candidate, a reference pattern of which a degree of reliability with respect to the characteristic vector is equal to or larger than 0.1. The speech recognizer 310 outputs, to the selector 320 and the response speech generator 330, information in which the extracted word candidate is associated with the degree of reliability.

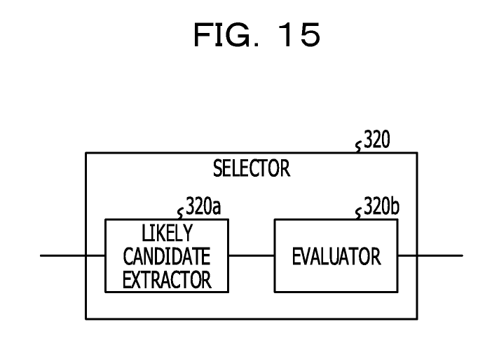

The selector 320 is a processor that selects a part corresponding to a difference between the plurality of word candidates. FIG. 15 is a diagram illustrating the configuration of the selector according to the third embodiment. As illustrated in FIG. 15, the selector 320 has a likely candidate extractor 320a and an evaluator 320b.

The likely candidate extractor 320a extracts, on the basis of the degrees of reliability of the plurality of word candidates, a word candidate of which a degree of reliability is equal to or larger than a predetermined threshold. The likely candidate extractor 320a outputs information of a combination of the extracted word candidate and the degree of reliability of the word candidate to the evaluator 320b. A word candidate of which a degree of reliability is largest is referred to as a first word candidate, while the other word candidates are referred to as second word candidates.

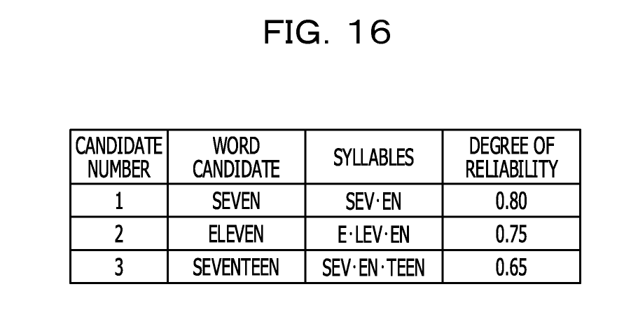

FIG. 16 is a diagram illustrating an example of the word candidates extracted by the likely candidate extractor according to the third embodiment and the degrees of reliability of the extracted word candidates. As illustrated in FIG. 16, syllables of a first word candidate “seven” are “sev” and “en”. Syllables of a second word candidate “eleven” are “e”, “lev”, and “en”. Syllables of another second word candidate “seventeen” are “sev”, “en”, and “teen”.

The evaluator 320b calculates scores for matching the first word candidate with the second word candidates, sums the calculated matching scores, and calculates a final matching score for the first word candidate. For example, the evaluator 320b compares the first word candidate “seven” with the second word candidate “eleven” and calculates a matching score. In addition, the evaluator 320b compares the first word candidate “seven” with the second word candidate “seventeen” and calculates a matching score. The evaluator 320b sums the matching scores and calculates a final matching score for the first word candidate.

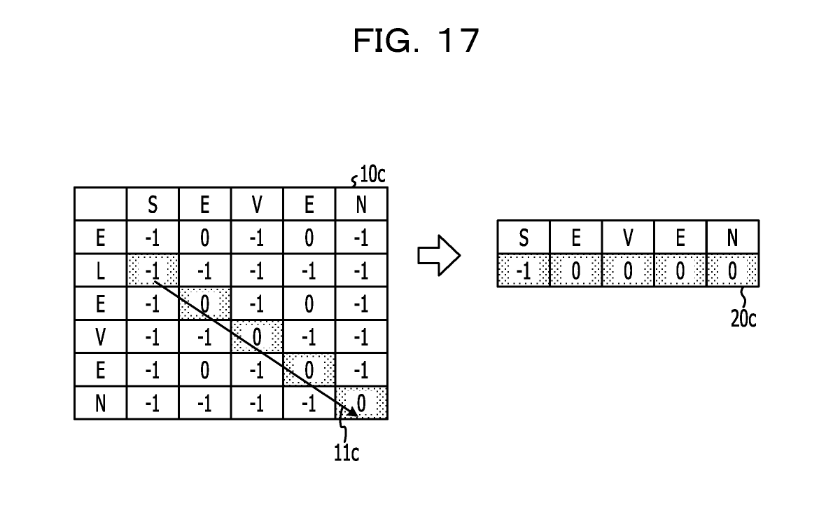

The evaluator 320b uses DP matching to calculate the matching scores, for example. FIGS. 17, 18, and 19 are diagrams describing a process that is executed by the evaluator according to the third embodiment. First, the process is described with reference to FIG. 17. FIG. 17 describes the process of comparing the first word candidate “seven” with the second word candidate “eleven”. The evaluator 320b compares characters of the first word candidates with characters of the second word candidate. If a character of the first word candidate matches a character of the second word candidate, the evaluator 320b provides a score “0” to the character of the first word candidate. If the character of the first word candidate does not match the character of the second word candidate, the evaluator 320b provides a score “−1” to the character of the first word candidate. In this manner, the evaluator 320b generates a table 10c by providing the scores.

The evaluator 320b identifies scores for the characters of the first word candidate by selecting a path on which larger scores among scores for the characters of the first word candidate exist on the basis of the table 10c on a priority basis. In an example illustrated in FIG. 17, a path 11c is selected and scores for the characters of the first word candidate are indicated in a score table 20c. Specifically, a score for “s” is “−1” and scores for “e”, “v”, “e”, and “n” are “0”.

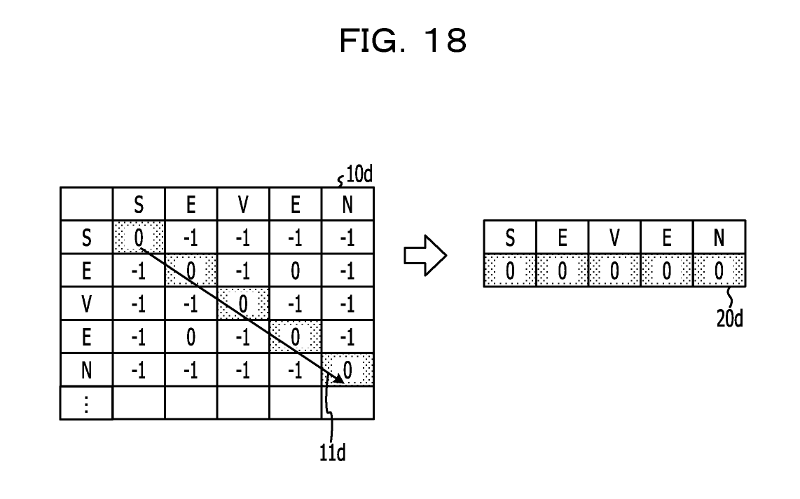

The process is described with reference to FIG. 18. FIG. 18 illustrates the process of comparing the first word candidate “seven” with the second word candidate “seventeen”. The evaluator 320b compares the characters of the first word candidate with the characters of the second word candidate. If a character of the first word candidate matches a character of the second word candidate, the evaluator 320b provides the score “0”. If the character of the first word candidate does not match the character of the second word candidate, the evaluator 320b provides the score “−1”. In this manner, the evaluator 320b generates a table 10d by providing the scores. If the number of the characters of the first word candidate is smaller than the number of characters of a second word candidate, the evaluator 320b compares the first word candidate with the second word candidate for the number of the characters of the first word candidate. For example, if the first word candidate “seven” is to be compared with the second word candidate “seventeen”, the evaluator 320b compares the characters of the first word candidate with characters “seven” included in the characters of the second word candidate “seventeen”.

The evaluator 320b identifies scores for the characters of the first word candidate by selecting a path on which larger scores among scores for the characters of the first word candidate exist on the basis of the table 10d on a priority basis. In an example illustrated in FIG. 18, a path 11d is selected and scores for the characters of the first word candidate are indicated in a score table 20d. Specifically, the scores for “s”, “e”, “v”, “e”, and “n” are “0”.

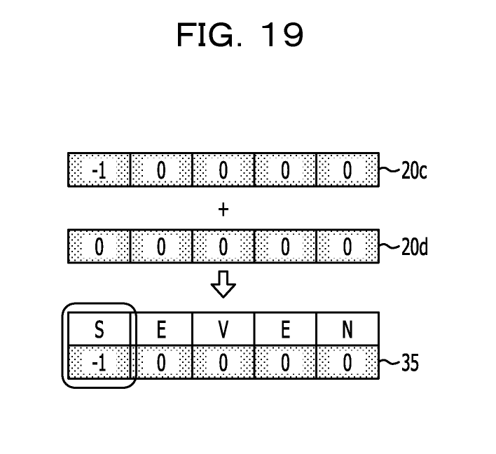

The process is described with reference to FIG. 19. The evaluator 320b sums the score table 20c and the score table 20d for each of the characters of the first word candidate and thereby calculates a score table 35 for the first word candidate.

The evaluator 320b selects, on the basis of the score table 35, a part corresponding to a difference between the first word candidate and the second word candidates. For example, the evaluator 320b selects a score that is smaller than “0” from among scores of the score table 35. Then, the evaluator 320b selects, as the part corresponding to the difference, a character corresponding to the selected score. In an example illustrated in FIG. 19, the evaluator 320b selects, as the part corresponding to the difference, a character “s” from among the characters of the first word candidate “seven”. The evaluator 320b outputs information of the part corresponding to the difference to the emphasis controller 330b.

Return to FIG. 14. The response sentence generator 330a is a processor that generates a response sentence that is used to prompt the user to check whether or not a speech recognition result is correct. For example, the response sentence generator 330a holds templates of character strings of multiple types and generates a response sentence by synthesizing a word candidate received from the speech recognizer 310 with a template. The response sentence generator 330a outputs information of the generated response sentence to the emphasis controller 330b and the text synthesizer 330c.

For example, when receiving a plurality of word candidates, the response sentence generator 330a selects a word candidate having the largest degree of reliability and generates a response sentence. For example, if the word candidate of which the degree of reliability is largest is “seven”, the response sentence generator 330a synthesizes the word candidate “seven” with a template “o'clock?” and generates a response sentence “Seven o'clock?”.

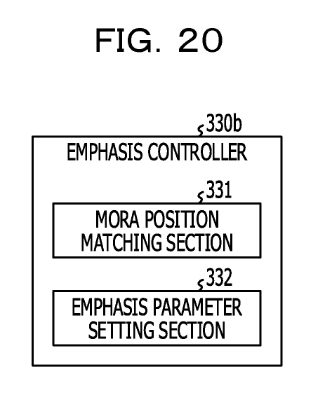

The emphasis controller 330b is a processor that selects a part included in the response sentence and to be emphasized and notifies the text synthesizer 330c of the selected part to be emphasized and a parameter for emphasizing the part. FIG. 20 is a diagram illustrating the configuration of the emphasis controller according to the third embodiment. As illustrated in FIG. 20, the emphasis controller 330b has a mora position matching section 331 and an emphasis parameter setting section 332.

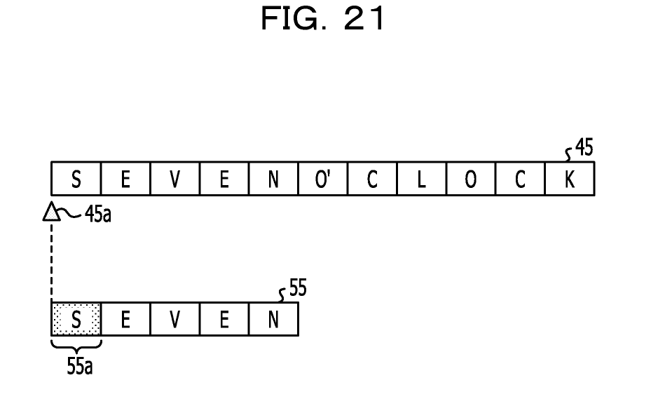

The mora position matching section 331 is a processor that selects, on the basis of the information received from the evaluator 320b and indicating the part corresponding to the difference, a part included in the response sentence and to be emphasized. FIG. 21 is a diagram describing a process that is executed by the mora position matching section according to the third embodiment. As illustrated in FIG. 21, the mora position matching section 331 crosschecks a start mora position 45a of a response sentence 45 with a part 55a included in a word candidate 55 and corresponding to a difference between word candidates and calculates a part included in the response sentence 45 and to be emphasized. In an example illustrated in FIG. 21, a character that is included in the response sentence 45 and corresponds to the part 55a corresponding to the difference is the first character “s”. Thus, the part to be emphasized is a mora 1. The mora position matching section 331 may identify a part to be emphasized on a syllable basis. For example, since the first character “s” is included in the syllable “sev”, the mora position matching section 331 may identify the characters “sev” as the part to be emphasized. In this case, the part to be emphasized is moras 1 to 3.

The emphasis parameter setting section 332 outputs a parameter indicating a set amplitude amount to the text synthesizer 330c. For example, the emphasis parameter setting section 332 outputs, to the text synthesizer 330c, information indicating that “the part to be emphasized is amplified by 10 dB”.

The text synthesizer 330c is a processor that generates, on the basis of the information of the response sentence, information of the part to be emphasized, and the parameter for the emphasis, response speech including emphasized speech of the part and corresponding to the response sentence and outputs the generated response speech. For example, the text synthesizer 330c executes the language analysis on the response sentence, identifies prosodies corresponding to words of the response sentence, synthesizes the identified prosodies, and generates the response speech. The text synthesizer 330c emphasizes a prosody of speech corresponding to a character of the part to be emphasized and generates the response speech including the emphasized speech of the part.

For example, if the part to be emphasized is the “moras 1 to 3” and the parameter indicates that “the part to be emphasized will be amplified by 10 dB”, the text synthesizer 330c amplifies, by 10 dB, power of speech of the part “Sev” included in the response sentence “Seven o'clock?” and generates response speech of the response sentence. The response speech generated by the text synthesizer 330c is output from a speaker or the like. For example, the response speech is output, while the speech of the part “Sev” included in the response sentence “Seven o'clock?” is more emphasized than the other words.

The parameter for emphasizing the part is not limited to the aforementioned parameter. For example, if the parameter indicates that “the persistence length of the part to be emphasized will be doubled”, the text synthesizer 330c doubles the persistence length of a prosodic part of the part “Sev” of the response sentence “Seven o'clock?” and generates response speech of the response sentence. For example, if the parameter indicates that “the pitch of the part to be emphasized will be doubled”, the text synthesizer 330c doubles the pitch of the prosodic part of the part “Sev” of the response sentence “Seven o'clock?” and thereby generates response speech including speech that corresponds to the emphasized part and is lower than normal speech.

Next, effects of the speech processing apparatus 300 according to the third embodiment are described. The speech processing apparatus 300 selects, on the basis of a plurality of word candidates recognized by the speech recognizer 310, a part corresponding to a difference between the plurality of word candidates. The speech processing apparatus 300 outputs response speech including the part that corresponds to the difference between the plurality of word candidates and of which the volume has been increased. Since the speech processing apparatus 300 according to the third embodiment emphasizes only speech of a part corresponding to a difference between word candidates without emphasizing speech of an overall word and outputs response speech including the emphasized speech of the part, an error of a speech recognition result may be easily found. In addition, if this technique is applied to the speech interaction system, the user may easily notice an erroneously recognized part and correctly pronounce a phrase, and the efficiency of an interaction executed to correct the erroneous recognition may be improved.

### Fourth Embodiment

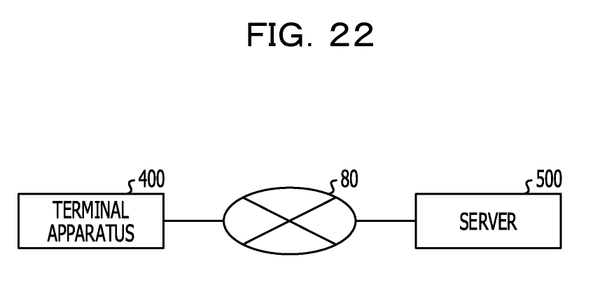

A speech processing system according to the fourth embodiment is described below. FIG. 22 is a diagram illustrating an example of the speech processing system according to the fourth embodiment. As illustrated in FIG. 22, the speech processing system has a terminal apparatus 400 and a server 500. The terminal apparatus 400 and the server 500 are connected to each other through a network 80.

The terminal apparatus 400 uses a microphone or the like to receive speech from a user and transmits information of the received speech to the server 500. The terminal apparatus 400 receives information of response speech from the server 500 and outputs the received response speech from a speaker or the like.

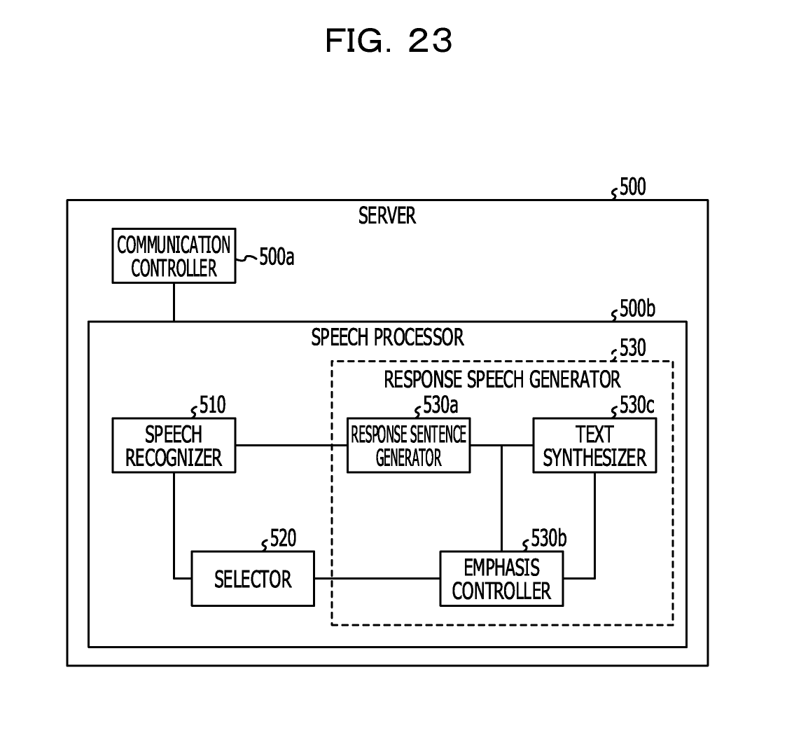

The server 500 has the same functions as the speech processing apparatuses according to the first to third embodiments. FIG. 23 is a diagram illustrating the configuration of the server according to the fourth embodiment. As illustrated in FIG. 23, the server 500 has a communication controller 500a and a speech processor 500b. The speech processor 500b has a speech recognizer 510, a selector 520, and a response speech generator 530. The response speech generator 530 has a response sentence generator 530a, an emphasis controller 530b, and a text synthesizer 530c.

The communication controller 500a is a processor that executes data communication with the terminal apparatus 400. The communication controller 500a outputs, to the speech recognizer 510, information of speech received from the terminal apparatus 400. In addition, the communication controller 500a transmits, to the terminal apparatus 400, information of response speech output from the text synthesizer 530c.

The speech recognizer 510 is a processor that receives information of speech from the communication controller 500a, executes the speech recognition so as to convert the speech into a word, and extracts a plurality of word candidates corresponding to the speech. In addition, the speech recognizer 510 calculates degrees of reliability of the word candidates. The speech recognizer 510 outputs, to the selector 520 and the response sentence generator 530a, information in which the word candidates are associated with the degrees of reliability.

The selector 520 is a processor that selects a part corresponding to a difference between the plurality of word candidates. A specific description of the selector 520 is the same as or similar to the descriptions of the selectors 120, 220, and 320 described in the first to third embodiments.

The response sentence generator 530a is a processor that generates a response sentence that is used to prompt the user to check whether or not a speech recognition result is correct. A process that is executed by the response sentence generator 530a to generate the response sentence is the same as or similar to the process executed by the response sentence generator 130a according to the first embodiment. The response sentence generator 530a outputs information of the generated response sentence to the emphasis controller 530b and the text synthesizer 530c.

The emphasis controller 530b is a processor that selects a part included in the response sentence and to be emphasized and notifies the text synthesizer 530c of the selected part to be emphasized and a parameter for emphasizing the part. The emphasis controller 530b identifies the part to be emphasized in the same manner as the emphasis controller 130b according to the first embodiment. The emphasis controller 530b outputs, to the text synthesizer 530c, information indicating that “the persistence length of the part to be emphasized will be doubled” as the parameter. The emphasis controller 530b may output, to the text synthesizer 530c, information indicating that “the part to be emphasized will be amplified by 10 dB” as the parameter. In the same manner as the second embodiment, the parameter may be the information indicating that “the persistence length of the part to be emphasized will be doubled” or the information indicating that “the pitch of the part to be emphasized will be doubled”.

The text synthesizer 530c is a processor that generates, on the basis of the information of the response sentence, the information of the part to be emphasized, and the parameter for emphasizing the part, response speech of the response sentence including emphasized speech of the part and outputs the generated response speech. For example, the text synthesizer 530c executes the language analysis on the response sentence, identifies prosodies corresponding to words of the response sentence, synthesizes the identified prosodies, and generates the response speech. The text synthesizer 530c emphasizes a prosody of speech corresponding to a character of the part included in the response speech and to be emphasized and thereby generates the response speech including the emphasized speech of the part. The text synthesizer 530c outputs information of the generated response speech to the communication controller 500a.

Next, effects of the server 500 according to the fourth embodiment are described. The server 500 selects a part corresponding to a difference between a plurality of candidates recognized by the speech recognizer 510. The server 500 outputs response speech including speech of which the volume has been increased and that corresponds to the part corresponding to the difference between the word candidates. Since the server 500 according to the fourth embodiment emphasizes only speech of a part corresponding to a difference between word candidates without emphasizing speech of an overall word and outputs response speech including the emphasized speech of the part, an error of a speech recognition result may be easily found. If this technique is applied to the speech interaction system, the user may easily find an erroneously recognized part and correctly pronounce a phrase, and the efficiency of an interaction executed to correct the erroneous recognition may be improved.

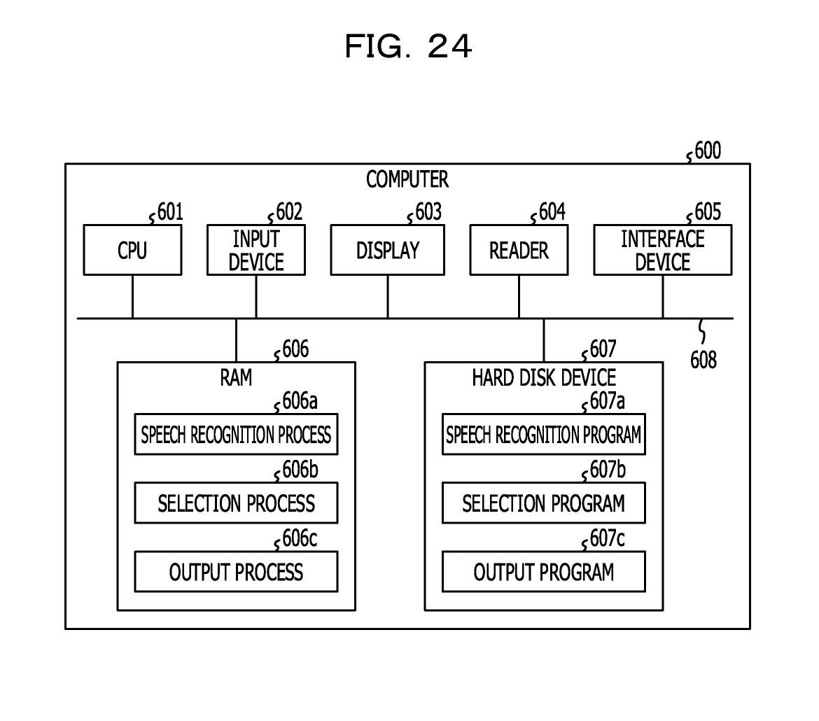

Next, an example of a computer that executes a speech processing program that achieves the same functions as the speech processing apparatuses according to the first to third embodiments is described. FIG. 24 is a diagram illustrating the example of the computer that executes the speech processing program.

As illustrated in FIG. 24, a computer 600 has a CPU 601 for executing arithmetic processing of various types, an input device 602 for receiving an entry of data from a user, and a display 603. The computer 600 also has a reader 604 for reading the program and the like from a recording medium and an interface device 605 for transmitting and receiving data to and from another computer through a network. The computer 600 also has a RAM 606 for temporarily storing information of various types and a hard disk device 607. The devices 601 to 607 are connected to each other by a bus 608.

The hard disk device 607 has a speech recognition program 607a, a selection program 607b, and an output program 607c. The CPU 601 reads the programs 607a to 607c and loads the programs 607a to 607c into the RAM 606.

The speech recognition program 607a functions as a speech recognition process 606a. The selection program 607b functions as a selection process 606b. The output program 607c functions as an output process 606c.

For example, the speech recognition process 606a corresponds to the speech recognizers 110, 210, 310, and 510. The selection process 606b corresponds to the selectors 120, 220, 320, and 520. The output process 606c corresponds to the response speech generators 130, 230, 330, and 530.

The programs 607a to 607c may not be stored in the hard disk device 607. For example, the programs 607a to 607c may be stored in a “portable physical medium” that is inserted in the computer 600 and is, for example, a flexible disk (FD), a CD-ROM, a DVD, a magneto-optical disc, or an IC card. The computer 600 may read the programs 607a to 607c from the portable physical medium and execute the programs 607a to 607c.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A speech processing method executed by a computer, the speech processing method comprising:
extracting, based on speech recognition for an input speech data, a plurality of word candidates including a first word candidate and a second word candidate from a memory, the plurality of word candidates being candidates for a word corresponding to the input speech data;
determining at least one different part between the first word candidate and the second word candidate based on a comparison between the first word candidate and the second word candidate; and
outputting the first word candidate with emphasis on the at least one different part.

2. The speech processing method according to claim 1, further comprising:
calculating a degree of reliability indicating similarity with respect to the input speech data, regarding each of the plurality of word candidates; and
identifying, from among the plurality of word candidates, the first word candidate and the second word candidate having degree of reliability which are equal to or larger than a threshold.

3. The speech processing method according to claim 1, further comprising:
calculating a degree of reliability indicating similarity with respect to the input speech data, regarding each of the plurality of word candidates;
identifying, from among the plurality of word candidates, the first word candidate which has a degree of reliability which is the largest, and the second word candidate which has a degree of reliability which is different by a value that is smaller than a threshold from the largest degree of reliability.

4. The speech processing method according to claim 1, wherein the outputting outputs speech data of the first word candidate with the emphasis, the speech data being stored in the memory and associated with the first word candidate.

5. The speech processing method according to claim 4, wherein the speech data is output with a first strength for the at least one different part and a second strength for rest of the first word candidate, wherein the first strength is stronger than the second strength.

6. The speech processing method according to claim 4, wherein the speech data is output with a first reproduction speed for the at least one different part and a second reproduction speed for rest of the first word candidate, wherein the first reproduction speed is slower than the second reproduction speed.

7. The speech processing method according to claim 4, wherein the speech data is output with a first fundamental frequency for the at least one different part and a second fundamental frequency for rest of the first word candidate, wherein the first fundamental frequency is different from the second fundamental frequency.

8. The speech processing method according to claim 1, wherein the plurality of word candidate are character strings respectively, and the at least one different part are determined based on the comparison between a first character strings of the first word candidate and a second character strings of the second word candidate.

9. The speech processing method according to claim 8, wherein the determining identifies, based on the comparison, a first portion of the first character strings and second portion of the first character strings, the first portion including characters same with a part of the second character strings in same positions, and the second portion being the at least one different part.

10. The speech processing method according to claim 8, wherein the at least one different part is determined using dynamic programming matching for the first character strings and the second character strings.

11. A speech processing device comprising:
a memory; and
a processor coupled to the memory and configured to:
extract, based on speech recognition for an input speech data, a plurality of word candidates including a first word candidate and a second word candidate from the memory, the plurality of word candidates being candidates for a word corresponding to the input speech data,
determine at least one different part between the first word candidate and the second word candidate based on a comparison between the first word candidate and the second word candidate, and
output the first word candidate with emphasis on the at least one different part.

12. The speech processing device according to claim 11, wherein the processor is further configured to:
calculate a degree of reliability indicating similarity with respect to the input speech data, regarding each of the plurality of word candidates, and
identify, from among the plurality of word candidates, the first word candidate and the second word candidate having degree of reliability which are equal to or larger than a threshold.

13. The speech processing device according to claim 11, wherein the processor is further configured to:
calculate a degree of reliability indicating similarity with respect to the input speech data, regarding each of the plurality of word candidates,
identify, from among the plurality of word candidates, the first word candidate which has a degree of reliability which is the largest, and the second word candidate which has a degree of reliability which is different by a value that is smaller than a threshold from the largest degree of reliability.

14. The speech processing device according to claim 11, wherein the plurality of word candidate are character strings respectively, and the at least one different part are determined based on the comparison between a first character strings of the first word candidate and a second character strings of the second word candidate.

15. The speech processing device according to claim 14, wherein the at least one different part is determined using dynamic programming matching for the first character strings and the second character strings.

16. A speech processing method executed by a computer, comprising:
selecting a word candidate from among a plurality of word candidates corresponding to input speech data;
determining at least one different part of the selected word candidate corresponding to a difference between the selected word candidate and at least one of the other of the plurality of word candidates; and
outputting speech of the selected word candidate, the speech distinguishing the at least one different part of the selected word candidate from the rest of the selected word candidate.

17. A system comprising:
a terminal device including a first memory and a first processor, the first processor coupled to the first memory and configured to transmit first speech information of an input speech data; and
a server including a second memory and a second processor, the second processor coupled to the second memory and configured to:
receive the first speech information from the terminal device,
extract, based on an input speech data, a plurality of word candidates including a first word candidate and a second word candidate from a memory, the plurality of word candidates being candidates for a word corresponding to the input speech data,
determine at least one different part between the first word candidate and the second word candidate based on a comparison between the first word candidate and the second word candidate, and
output the first word candidate with emphasis on the at least one different part.
